(19) United States
(12) Patent Application Publication
(10) Pub. No.: US 2017/0047096 A1
(43) Pub. Date: Feb. 16, 2017

(54) VIDEO GENERATING SYSTEM AND METHOD THEREOF

(71) Applicant: HTC Corporation, Taoyuan City (TW)

(72) Inventor: Kuan-Wei LI, Taoyuan City (TW)

(21) Appl. No.: 14/979,572

(22) Filed: Dec. 28, 2015

(30) Foreign Application Priority Data
Aug. 10, 2015 (TW) 104125994

(51) Int. Cl. G11B 27/34; G06K 9/00

(52) U.S. Cl. CPC G11B 27/34; G06K 9/00315; G06K 9/00885; G06K 9/00718; G06K 2009/00939

(57) ABSTRACT

An video management method is provided. The video management method includes following steps. A video file is captured. Wherein an emotion tag corresponding to the image file is generated when capturing the video file. As such, the video file can be managed, classified, edited or added effects according to the scenario at the moment of capturing the video file.

### RELATED APPLICATIONS

This application claims priority to Taiwanese Application Serial Number 104125994 filed Aug. 10, 2015, the entirety of which is herein incorporated by reference.

### BACKGROUND

Field of Invention

The present invention relates to a video management system and method thereof. More particularly, the present invention relates to video management system and method thereof with applying an emotion tag.

Description of Related Art

With the development of technology, digital image has been widely applied in people's daily life. In general, user may store the large amount of digital images in the electronic devices. Users can manually classify the digital images or manage these digital images by the order of the default configuration. For example, users can sort by file size, modification date or file name to manage the digital images.

However, it is hard for users to determine or record the current emotion or the current physiological information of the photographer or the photographed for each digital image while capturing the large amount of images in order to manage these digital images. On the other hand, when the user wants to apply a special effect to the images, no matter the user manually or automatically selects the image effect, the image effect will be applied to all images or frames to make the whole video segment having the same effect. As such, the image effect cannot be properly applied to the video segment corresponding to the emotion or the physiological information of the photographer or the photographed at the moment of capturing the images. Therefore, this situation causes the limitation of digital image application.

### SUMMARY

One aspect of the present disclosure is related to a management method. The method includes: capturing a video file; wherein an emotion tag corresponding to the video file is generated when capturing the video file.

Another aspect of the present disclosure is related to a video management system. In accordance with one embodiment of the present disclosure, the video management system includes: a video capture module and a processing device. The video capture module is configured far capturing a video file. The processing device is configured for generating an emotion tag corresponding to the video file when the video capture module captures the video file.

Through the video management method and the video management system described above, user can obtain the emotion or the physiological information of the photographer or the photographed from each video file of the large amount video files. And, an emotion tag corresponding to the video file is generated according to emotion or the physiological information. Therefore, it is more flexible and more convenient to manage the video files, classify the video files, edit the video files or apply the effects to the video files.

### BRIEF DESCRIPTION OF THE DRAWINGS

FIG. 1 is a block diagram of a video management system according to one embodiment of the present invention.

FIG. 2 is a block diagram of the internal components of a sensing module according to one embodiment of the present invention.

FIG. 3 is a flowchart of a video management method according to one embodiment of the present invention.

FIG. 4 is a block diagram of a video management system according to one embodiment of the present invention.

FIG. 5 is a schematic diagram of a user interface of a video management system according to one embodiment of the present invention.

FIG. 6 is a schematic diagram of a user interface of a video management system according to one embodiment of the present invention.

FIG. 7 is a schematic diagram of a user interface of a video management system according to one embodiment of the present invention.

### DETAILED DESCRIPTION

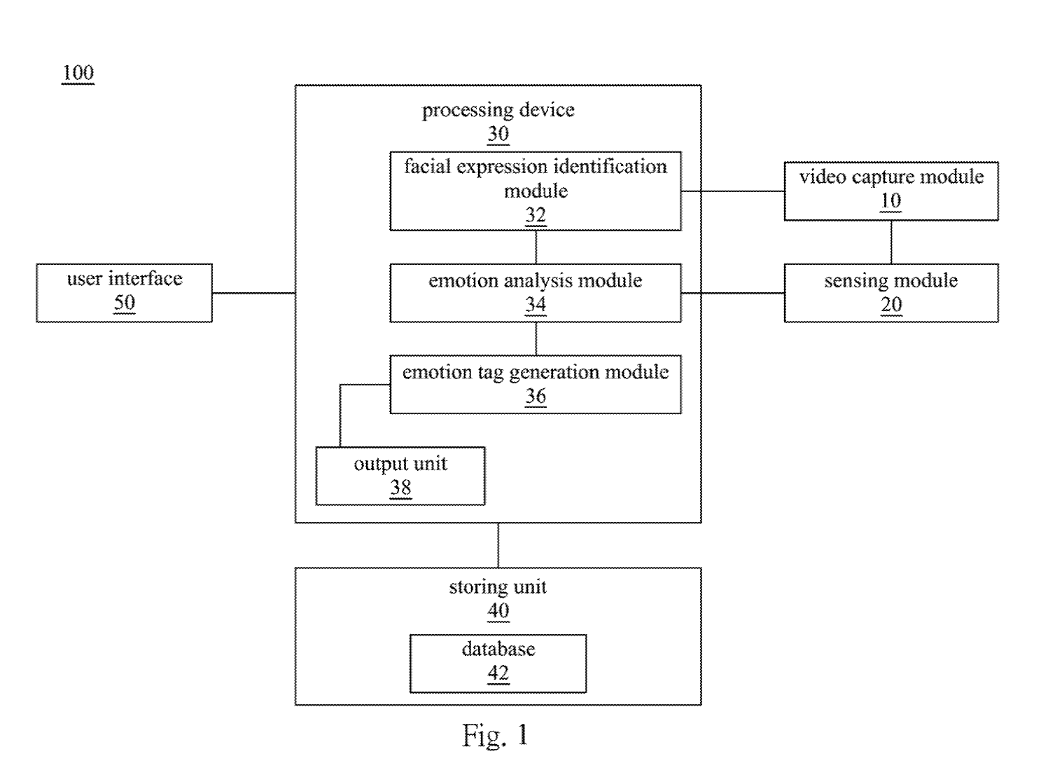

Reference is made to FIG. 1, FIG. 1 is a block diagram of a video management system 100 according to one embodiment of the present invention. As shown in FIG. 1, the video management system 100 includes: a video capture module 10 and a processing device 30. The video capture module 10 is configured for capturing a video file. The video capture module 10 is also coupled to the processing device 30 by wire or wireless method. The processing device 30 is configured for processing the video files captured by the video capture module 10.

In one embodiment, the processing device 30 includes a facial expression identification module 32, an emotion analysis module 34, an emotion tag generation module 36 and an output unit 38. The facial expression identification module 32 of the processing device 30 is electrically coupled to the video capture module 10. The emotion analysis module 34 is electrically coupled to the facial expression identification module 32. The emotion tag generation module 36 is electrically coupled to the emotion analysis module 34. The facial expression identification module 32 is configured for identifying a user's facial expression in the video file captured from the video capture module 10. The emotion analysis module 34 is configured for analyzing the emotion of the facial expression in the video file. For example, the emotion analysis module 34 compares the identified facial expression to the pre-stored expression in database 42 related to the emotion, so as to analyze that the captured facial expression belongs to what kinds of emotion. The emotion tag generation module 36 is configured for generating the emotion tag according to the emotion analysis module 34. The emotion tag generation module 36 also combines the emotion tag with the video file or generates the emotion tag corresponding to the video file, and then the emotion tag is stored in a default or specific temporary fodder (e.g. the emotion tag is stored in a storing unit 40). Next, when user wants to add a video effect corresponded to the emotion tag of the video file through the processing device 30, the output unit 38 outputs the video file, which is added the video effect.

It's worth mentioning that in every embodiment of present invention, the processing device 30 can be a processor or a controller. Wherein, the facial expression identification module 32, the emotion analysis module 34, the emotion tag generation module 36 and the output unit 38 configured in the processing device 30 can be implemented respectively or along with each other. And, the facial expression identification module 32, the emotion analysis module 34, the emotion tag generation module 36 and the output unit 33 can be implemented by a micro controller, a microprocessor, a digital signal processor, an application specific integrated circuit (ASIC), a firmware, a program, or a logical circuitry. The video capture module 10 can be a digital camera including a charge coupled device (CCD) or complementary metal-oxide semiconductor(CMOS) and a radio component.

In other words, the video capture module 10 is configured for capturing the video file. And, the processing device 30 is configured for generating the emotion tag corresponded to the video file. Wherein, the video file can include at least one of an image file, an audio file and a segment of a video. For example, user can use the video capture module 10 (e.g. a digital camera) to capture a video file and the content of the video file includes a child image. Next, the facial expression identification module 32 of the processing device 30 identifies the facial expression of the child. If the facial expression identification module 32 of the processing device 30 determines that the child's face expression is a smiling face, the emotion analysis module 34 analyzes the emotion of the child as a happy emotion. The emotion tag generation module 36 generates the emotion tag corresponding to the child's face image. In addition, this emotion tag is configured for presenting a happy property. For another example, the voice message of the child of the video file can be captured by the radio component of the video capture module 10. If the voice is noisy (for example, the default values of the voice frequency and the voice volume can be used as a judging criteria), the emotion analysis module 34 analyzes the emotion of the child as an exciting emotion. And, the emotion tag generation module 36 generates the emotion tag corresponded to the child's face image. In addition, this emotion tag is configured for presenting an exciting property. Therefore, the user can use the emotion tag to further classify the video file, edit the video file or apply the effect to the video file.

In one embodiment, the facial expression identification module 32 can use the voice or the face expression (e.g. an angle of the corner of the mouth up or a movement range of the corner of the eye) of the video file to determine the emotion of the photographer or the photographed. For example, when the facial expression identification module 32 determines the mouth up angle of the photographed of the video file is larger than an angle threshold, and also the photographer makes the sound louder, the emotion analysis module 34 can analyze that the photographer or the photographed has the exciting emotion at the moment of capturing the video file. And, the emotion tag generation module 36 generates the emotion tag corresponding to the segment of the video file. This emotion tag is configured for presenting the exciting emotion. Further, based on the video file captured by the video capture module 10, the emotion tag generation module 36 can generate the emotion tag corresponding to the video file, so as to manage the video file or apply the video file according to the emotion tag.

In one embodiment, the video management system 100 further includes a storage unit 40 for storing different kinds of data For example, the storage unit 40 can be implemented as memory, disk or memory card. In one embodiment, the storage unit 40 further includes a database 42.

In one embodiment, the video management system 100 further includes a user interface 50 for providing an operation interface to a user.

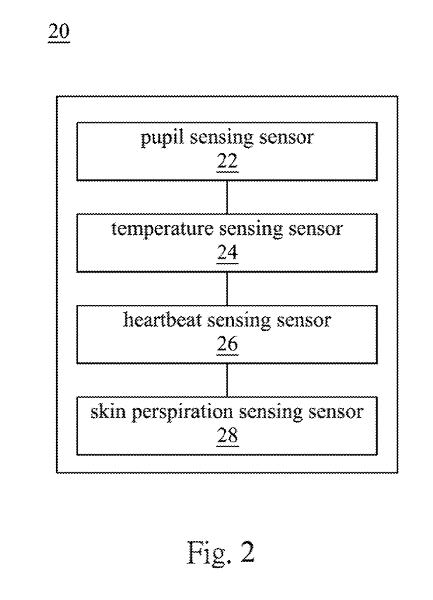

In one embodiment, the video management system 100 further includes sensing module 20. In one embodiment, the sensing module 20 is composed of at least one sensor. The sensing module 20 is coupled to the processing device 30 and the video capture module 10 by wire or wireless manner. The sensing module 20 is configured for measuring the physiological information sensing signal. The physiological information sensing signal can include a pupil sensing value, a temperature sensing value, a heartbeat sensing value and a skin perspiration sensing value. Please refer to FIG. 2, FIG. 2 is a block diagram of the internal components of a sensing module 20 according to one embodiment of the present invention. In FIG. 2, the sensing module 20 includes a pupil sensing sensor 22, a temperature sensing sensor 24, a heartbeat sensing sensor 26 and a skin perspiration sensing sensor 28. Wherein, the pupil sensing sensor 22 is configured for sensing the pupil size of user, the temperature sensing sensor 24 is configured for sensing the temperature of the user, the heartbeat sensing sensor 26 is configured for sensing the heartbeat frequency and the heartbeat times of the user, and the skin perspiration sensing sensor 28 is configured for sensing the perspiration degree of the user.

In one embodiment, the sensing module 20 is configured for using multiple sensors to detect the physiological information sensing signal at the moment of capturing the video file. And, the sensing module 20 transmits the physiological information sensing signal to the emotion analysis module 34 of the processing device 30. The emotion analysis module 34 determines an emotion property in accordance with the physiological information sensing signal and enables the emotion tag generation module 36 to generate the emotion tag according to the emotion property. For example, when the skin perspiration sensing sensor 28 detects the more sweat from the part of the photographer's skin which touched to the video capturing device and the pupil sensing sensor 22 calculates the larger pupil of the photographed of the video file, the emotion analysis module 34 determines that the photographer and the photographed both have the nervous or exciting emotion property. And, the emotion tag generation module 36 generates the emotion tag corresponding to the segment of video file. This emotion tag is configured for presenting a nervous or an exciting property. In another embodiment, the video management system 100 can adopt using the sensing module 20 and the expression identification module 32 in the same time to more precisely detect the current emotion of the user by the physiological information sensing signal and the facial expression at the moment of capturing the video file.

On the other hand, the video capture module 10, the sensing module 20, the processing device 30, the storing unit 40, the user interface 50 can be realized in a mobile device.

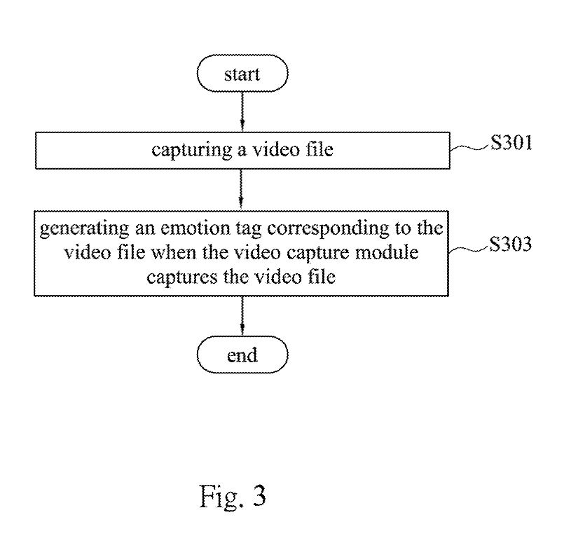

Next, please refer to FIGS. 1-3, FIG. 3 is a flowchart of a video management method 300 according to one embodiment of the present invention. To simplify the description below, in the following paragraphs, the video management system 100 shown in FIG. 1 will be used as an example to describe the video management method 300 shown in FIG. 3 according to the embodiment of the present disclosure. However, the present disclosure is not limited thereto.

In step S301, the video capture module 10 is configured for capturing a video file. In one embodiment, the video file includes a photo, a video or other media files. For example, user can use the video capture module 10 to capture the face image of a child.

In step S303, the processing device 30 is configured for generating an emotion tag corresponding to the video file when the video capture module 10 captures the video file. For example, the processing device 30 can generate an emotion tag corresponding to the video file. Wherein, the emotion tag can be generated by a facial expression detected from the expression identification module 32 of the processing device 30 or a physiological information sensing signal detected from the sensing module 20 of the processing device 30. In another embodiment, the processing device 30 can generate the emotion tag corresponding to the video file according to both facial expression and physiological information sensing signal. Besides, the emotion tag can be implemented as adding an emotion tag column to the file information column (e.g. the capturing video time column, location column, and file size column) of the video file. Or, the emotion tag can be implemented as further generating a tag file and attached the tag file to the video file, so as to record the emotion tag.

On another hand, the processing device 30 does not need to generate the emotion tag immediately. For example, the processing device 30 can use for generating an emotion tag after capturing or recording the video file.

In one embodiment, after the video capture module 10 obtains the video file and/or the sensing module 20 receives the physiological information sensing signal, the emotion tag corresponding to the video file is generated by the processing device 30 on the mobile device according to the physiological information sensing signal. And, the emotion tag is stored in the database 42 of the mobile device.

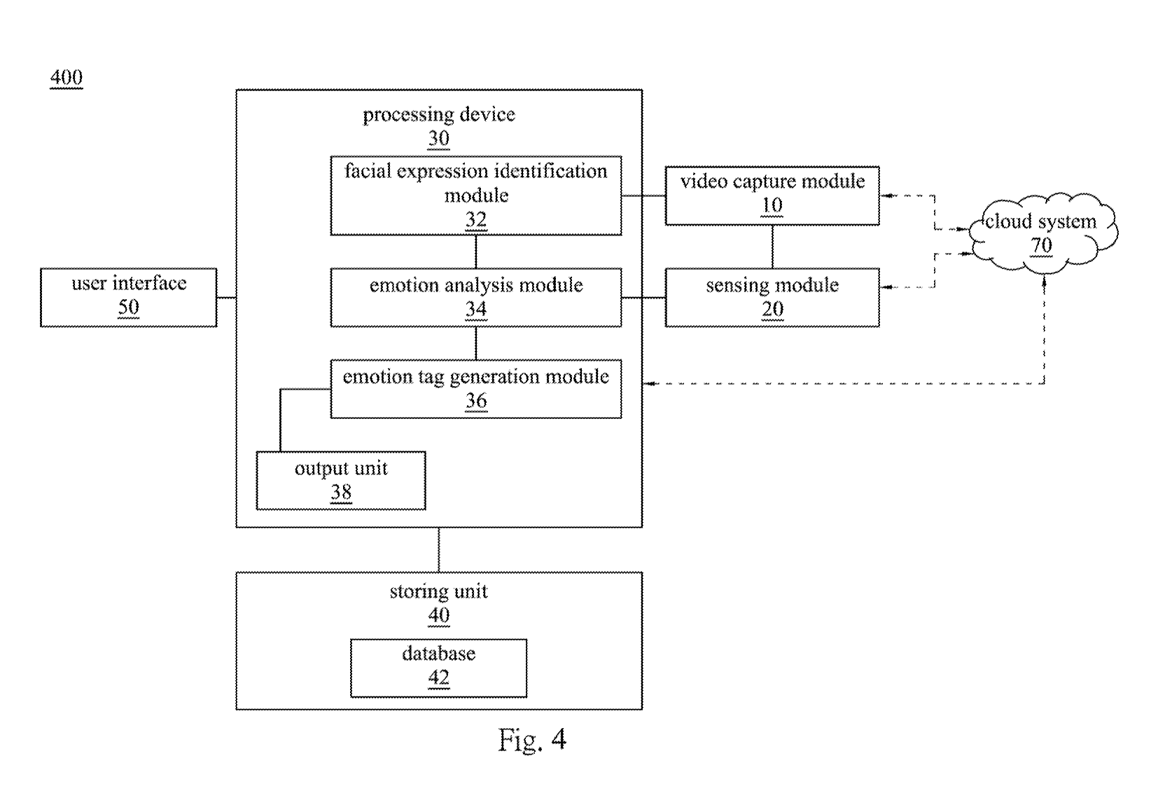

In another embodiment, please refer to FIG. 4, FIG. 4 is a block diagram of a video management system 400 according to one embodiment of the present invention. The difference between FIG. 1 and FIG. 4 is that FIG. 4 further includes a cloud system 70. Wherein, the cloud system 70 is coupled to the processing device 30, the video capture module 10 and the sensing module 20 by wire or wireless manner. Further, the cloud system 70 includes a server (not illustrated). In one embodiment, the processing device 30, the video capture module 10 and the sensing module 20 respectively includes a transmitting module. The transmitting module can transmit signal by wire or wireless manner.

In this embodiment, the cloud system 70 has the same function as the processing device 30. For example, in response to the video capture module 10 obtains the video file and/or the sensing module 20 receives the physiological information sensing signal, the video capture module 10 and/or the sensing module 20 respectively transmits the video file and/or the physiological information sensing signal to the server. In response to the video file and/or the physiological information sensing signal are transmitted, the server directly generates the emotion tag corresponding to the vide file according to the facial expression of the video file and/or the physiological information sensing signal and stores the emotion tag in the server.

Therefore, after captured the video file, the cloud system 70 can directly generate the emotion tag corresponding to the video file according to the facial expression of the video file and/or the physiological information sensing signal. If the processing device 30 requires the emotion tag, the emotion will be transmitted from the server to the processing device 30 for performing the following processes. In this embodiment, by transmitting the video file and/or the physiological information sensing signal to the cloud system 70, it can reduce the calculation loading of the processing device 30 placed in the mobile device.

Besides, in some embodiment, the processing device 30 can generate multiple emotion tags corresponding to each time points along with the emotion change of a person in the video file. The following paragraphs further describe the embodiment of generating at least one emotion tag corresponding to the at least one video file However, the video management system 100 and the video management method 300 of present invention should not be limited to the description of the embodiments contained herein.

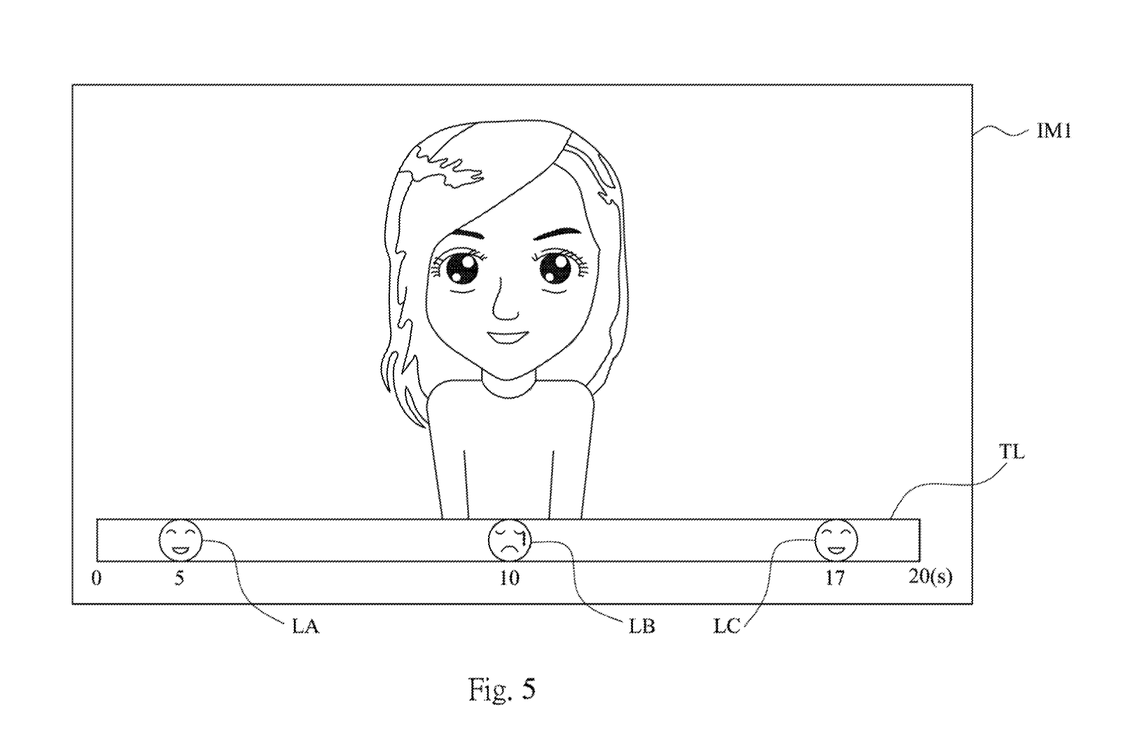

Please refer to FIG. 5, FIG. 5 is a schematic diagram of a user interface 50 of a video management system 100 according to one embodiment of the present invention. In FIG. 5, the recording length of the video file IM1 is 20 seconds. In the fifth second, the expression identification module 32 determines that the mouth up angle of the photographed is larger than an angle threshold and the heartbeat sensor 26 determines the heartbeat frequency is higher than a heartbeat threshold, the emotion analysis module 34 analyzes that the emotion of the person in the video file IM1 is positive and infers that the person is in a happy emotion, so as to make the emotion tag generation module 36 generates the emotion tag LA on the position of the fifth second of the video file timeline TL. For instance, the emotion tag LA can be presented as a smile symbol. In the tenth second, the expression identification module 32 determines that down-turned mouth angle of the photographed and the skin perspiration sensing sensor 28 determines that the temperature of the photographer is lower than a temperature threshold, the emotion analysis module 34 analyzes that the emotion of the person in the video file IM1 is negative and infers that the person is in a sad emotion, so as to make the emotion tag generation module 36 generates the emotion tag LB on the position of the tenth second of the video file timeline TL. For instance, the emotion tag LA can be presented as a crying face symbol. Next, In the seventeenth second, if the processing device 30 determines that the emotion of the person in the video file IM1 is positive and infers that the person is in a happy emotion, the processing device 30 generates the emotion tag LC on the position of the seventeenth second of the video file timeline TL.

Based on above, the video management system 100 can tag at least one emotion tag according to the emotions of each moment of capturing the video file. And, the video management system 100 can perform the other consequent applications according to the emotion tag.

In one embodiment, the processing device 30 can add the video effect according to the emotion property of the emotion tag. Wherein, the video effect includes at least one of an audio file, a word file and an image file.

For example, in FIG. 5, the processing device 30 adds the fancy frame effect and the delightful music to the segments (e.g. the fifth second and the seventeen second) of the video file IM1 corresponded to the emotion tag LA, LC presenting the happy emotion. The output unit 38 outputs this interesting video after adding the video frame. On the other hand, the processing device 30 adds the gray scale effect and the sad music to the segments of the video file IM1 corresponded to the emotion tag LB presenting the sad emotion. Also, the output unit 38 outputs the video after adding the video frame to present the emotion of the user at the video file capturing moment.

In another embodiment, the processing device 30 can separately generate the emotion tag LA LB and LC corresponding to the multiple segments of the video file IM1. After the processing device 30 analyzes an emotion change of the emotion tag LA, LB and LC, the processing device 30 selects at least one segment from the segments of the video file IM1 according the emotion change, which is corresponded to a default situation. Or, the processing device 30 selects the segments having the same emotion property after analyzing an emotion change of the emotion tag LA, LB and LC. And, the processing device 30 edits the at least one segment to form a selection file. For example, the processing device 30 selects the segments of the video file corresponded to the emotion tag LA, AC, which is presented the happy emotion, so as to generate a selection file of the video file IM1. For another example, if the emotion change presents that the default condition at the timing of the emotion tag LA, LB in the video file IM1 is changed from presenting happy emotion to presenting sad emotion, the processing device 30 clips the segments corresponded to the emotion tag LA, LB into a selection file of video file IM1.

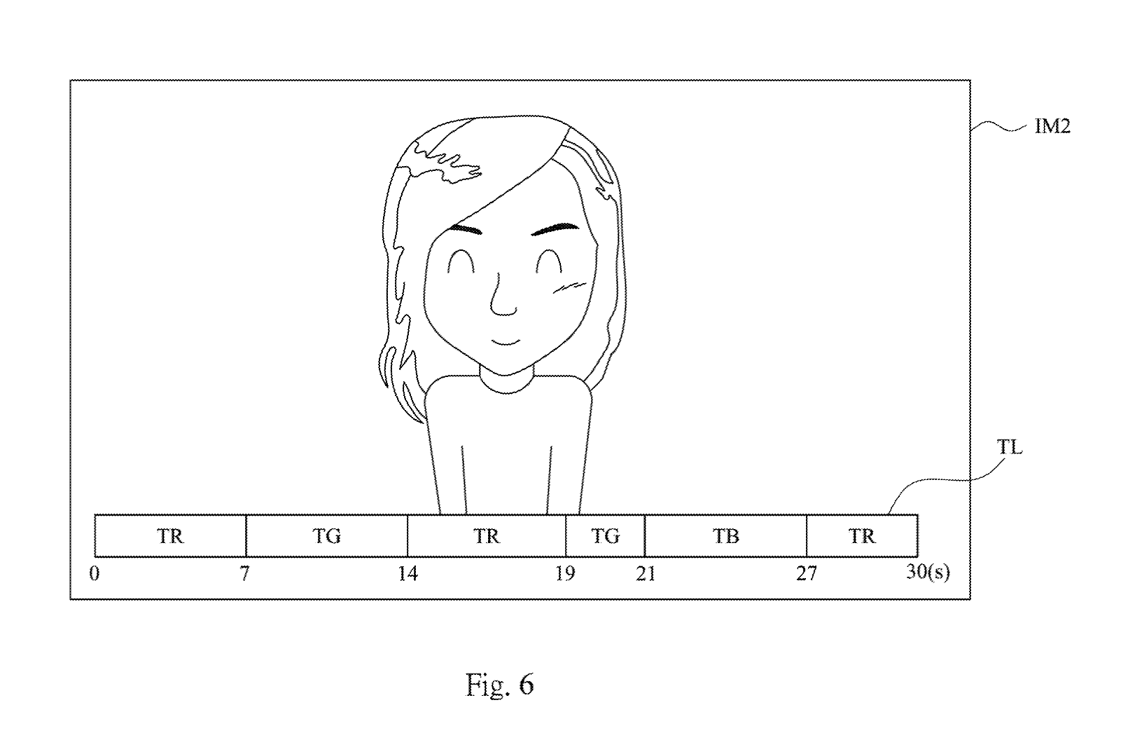

Next, please refer to FIG. 6, FIG. 6 is a schematic diagram of a user interface of a video management system according to one embodiment of the present invention. In one embodiment, the recording length of the video file IM2 is 30 seconds. In FIG. 6, the processing device 30 determines the emotion of the photographer and the photographed corresponding to each segment of the video file IM2 and marks each segment of the video file IM2 corresponded to different emotion by different colors of emotion tag. The processing device 30 adds at least one color mark or at least one label symbol in the video file IM2 and marks the at least one color mark or the at least one label symbol on a timeline TL of the video file IM2 according to the emotion tag TR, TG and TB when the video file is shown on the user interface 50.

For example, the processing device 30 determines that the emotion of photographer or the photographed as a happy property in the zero to the seventh seconds, the fourteenth to the nineteenth seconds, the twenty-seventh to the thirtieth seconds of the video file IM2. The processing device 30 marks a red line segment of emotion tag TR on the timeline TL. Besides, the processing device 30 determines that the emotion of photographer or the photographed as a sad property in the twenty-first to the twenty-seventh seconds of the video file IM2. The processing device 30 marks a blue line segment of emotion tag TB on the timeline TL. While the processing device 30 determines that the emotion of photographer or the photographed does not present any special emotion reaction in the seventh to fourteenth seconds and the nineteenth to twenty-first seconds of the video file IM2, the processing device 30 marks a green line segment of emotion tag TG on the timeline TL.

Therefore, the processing device 30 can determine the content of the video file IM2 to generate the multiple emotion tags TR, TG and TB according to the emotion of the photographer or the photographed at the moment of capturing the video file. In addition, the processing device 30 can add the different video effect corresponding to the emotion tags TR, TG and TB. For example, the processing device 30 applies the fancy word image and the delightful music to the segments corresponded to the emotion tag TR, which is presented the happy emotion (or positive emotion). Or, the processing device 30 applies the nostalgia effect and the sad music to the segments corresponded to the emotion tag TB, which is presented the sad emotion (or negative emotion) As such, the multiple effects of the emotion tag TR, TG and TB can be applied to each moment in the video file IM2, so as to bring more vivid visual effects to the user after applying the effects to the video file IM2.

In one embodiment, the user can select the menu button on the user interface 50 to enable the processing device 30 clips the video segments having the similar emotion property of the emotion tag to a selection file, such as clipping all the video segments having the emotion tag TR (the zero to the seventh seconds, the fourteenth to the nineteenth seconds, the twenty-seventh to the thirtieth seconds) in the video file IM2 to form a short video, so as to make this short video as a selection file of the video file IM2.

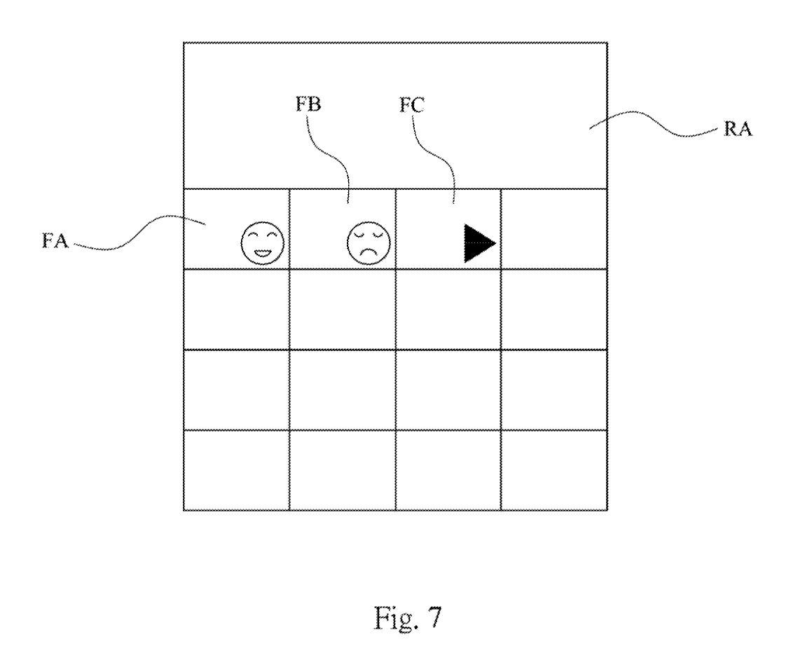

Next, please refer to FIG. 7, FIG. 7 is a schematic diagram of a user interface 50 of a video management system 100 according to one embodiment of the present invention. In this embodiment, the user interface 50 includes a file display area RA, an mage fodder FA, FB and a video fodder FC. The file display area RA is configured for automatically displaying the photos or videos according to the default display sequence or the random display sequence in real-time. The image fodder FA can use for storing the photo having the happy (or positive) emotion property of the emotion tag. The processing device 30 can further classifies the image file into the image fodder corresponded to the emotion tag. The video fodder FC can use for storing all the videos. In another embodiment, the processing device 30 can further classifies the videos by the video fodder FC according to the information, such as the amount of different kinds of emotion tags, the similarity of the emotion property or the length of the lasting time, so as to classify the videos into the positive emotion property videos or the negative emotion property videos.

Through the video management method and the video management system described above, the user can obtain the emotion or the physiological information of the photographer or the photographed from each video files. And, the emotion tag is generated according to the emotion and/or the physiological information at the moment of capturing each video foe. Therefore, it is more flexible and more convenient to manage the video files, classify the video files, edit the video files or apply the effects to the video files.

Although the present invention has been described in considerable detail with reference to certain embodiments thereof, other embodiments are possible. Therefore, the scope of the appended claims should not be limited to the description of the embodiments contained herein.

What is claimed is:

1. A video management method, comprising:
capturing a video file;
wherein an emotion tag corresponding to the video file is generated when capturing the video file.

2. The video management method of claim 1, wherein in the step of capturing the video file, further comprising:
detecting a physiological information sensing signal or a facial expression of the video file to generate the emotion tag.

3. The video management method of claim 2 wherein the emotion tag is generated according to an emotion property that is determined in accordance with the physiological information sensing signal,

4. The video management method of claim 2, wherein the physiological information sensing signal comprises a pupil sensing value, a temperature sensing value, a heartbeat sensing value and a skin perspiration sensing value.

5. The video management method of claim 1, further comprising:
applying at least one video effect to the video file corresponding to the emotion tag;
wherein the video effect comprises at least one of an audio file, a word file and an image file.

6. The video management method of claim 1, wherein the video file comprises an image file, the method further comprises:
classifying the image file into an image fodder corresponded to the emotion tag.

7. The video management method of claim 1, further comprising:
generating a plurality of emotion tags separately corresponding to a plurality of segments of the video file;
analyzing an emotion change of the emotion tags; and
selecting at least one segment from the segments of the video file according the emotion change, which is corresponded to a default situation, and the at least one segment is edited to form a selection file.

8. The video management method of claim 1, further comprising:
adding at least one color mark or at least one label symbol in the video file; and
marking the at least one color mark or the at least one label symbol on a timeline of the video file when the video file is shown on the user interface

9. The video management method of claim 1, further comprising:
transmitting the video file or the physiological information sensing signal to a server; after the video file or the physiological information sensing signal is transmitted, the emotion tag corresponding to the video file is generated according to the facial expression of the video file or the physiological information sensing signal on the server, and the emotion tag is stored in the server.

10. The video management method of claim 1, further comprising:
after obtaining the video file or receiving the physiological information sensing signal, the emotion tag of the video file is generated on a mobile device according to the physiological information sensing signal, and the emotion tag is stored in a database of the mobile device.

11. A video management system, comprising:
a video capture module for capturing a video file; and
a processing device for generating an emotion tag corresponding to the video file when capturing the video file.

12. The video management system of claim 11, further comprising:
a sensing module for detecting a physiological information sensing signal or a facial expression of the video file to generate the emotion tag.

13. The video management system of claim 12, the emotion tag is generated according to an emotion property that is determined in accordance with the physiological information sensing signal.

14. The video management system of claim 12, wherein the physiological information sensing signal comprises a pupil sensing value, a temperature sensing value, a heartbeat sensing value and a skin perspiration sensing value.

15. The video management system of claim 11, wherein the processing device is configured for applying at least one video effect to the video file corresponding to the emotion tag; wherein the video effect comprises at least one of an audio file, a word file and an image file.

16. The video management system of claim 11, wherein the video file comprises an image file, the processing device classifies the image file into an image fodder corresponded to the emotion tag.

17. The video management system of claim 11, wherein the processing device is configured for generating a plurality of emotion tags separately corresponding to a plurality of segments of the video file, so as to analysis an emotion change of the emotion tags; the processing device selects at least one segment from the segments of the video file according the emotion change, which is corresponded to a default situation, and the processing device edits the at least one segment to form a selection file.

18. The video management system of claim 11, further comprising:
an user interface;
wherein the processing device is configured for adding at least one color mark or at least one label symbol in the video file, and the at least one color mark or the at least one label symbol is marked on a timeline of the video file when the video file is shown on the user interface.

19. The video management system of claim 11, wherein the video capture module transmits the video file to a server or a sensing module transmits the physiological information sensing signal to the server; after the video file or the physiological information sensing signal is transmitted, the emotion tag corresponding to the video file is generated according to the facial expression of the video file or the physiological information sensing signal on the server, and the emotion tag is stored in the server.

20. The video management system of claim 11, wherein after the video capture module obtains the video file or a sensing module receives the physiological information sensing signal, the emotion tag of the video file is generated on a mobile device according to the physiological information sensing signal, and the emotion tag is stored in a database of the mobile device.
